(19) United States
(12) Patent Application Publication
(10) Pub. No.: US 2008/0121688 A1
(43) Pub. Date: May 29, 2008

(54) Multiple Barcode Format Labelling System and Method

(75) Inventor: Andrew Harrop, Devon (GB)

Correspondence Address: David W. Highet, VP & Chief IP Counsel;Becton, Dickinson and Company, (The Webb Firm), 1 Becton Drive, MC 110, Franklin Lakes, NJ, 07414-1880, US

(73) Assignee: BECTON, DICKINSON AND COMPANY, Franklin Lakes, NJ (US)

(21) Appl. No.: 11/847,616

(22) Filed: Aug. 30, 2007

Related U.S. Application Data
(60) Provisional application No. 60/823,920, filed on Aug. 30, 2006.

(51) Int. Cl. G06F 19/00; G06K 19/06

(52) U.S. Cl. 235/375; 235/494

(57) ABSTRACT

A label comprises a first area having a first barcode printed thereon and a second area having a second barcode printed thereon. The first barcode is of a first format, the second barcode is of a second format and each barcode encodes at least a subset of identical information. The subset of identical information encoded in the first barcode and the second barcode may include information identifying the patient, the type of sample, or date or time of sampling, or any combination thereof.

### CROSS REFERENCE TO RELATED APPLICATIONS

This application claims the benefit of U.S. Provisional Patent Application No. 60/823,920 entitled “Multiple Barcode Format Labelling System and Method” filed Aug. 30, 2006, which is hereby incorporated by reference in its entirety.

### BACKGROUND OF THE INVENTION

1. Field of the Invention

The present invention relates generally to labels for use with specimen collection containers and, more particularly, to labels including multiple barcodes having different formats and encoding the same information.

2. Description of Related Art

It is common for medical specimens to be collected by a technician in a collection container for subsequent testing. Blood specimens are typically collected in blood collection tubes. These tubes are transported or shipped to a test facility together with documentation relating to the particular test and to the patient from which the blood specimen was taken.

Much of the information which identifies the type of tube, the test, and/or the patient, can be reduced to a scannable bar code which can be placed on the blood collection tube. The bar code is typically applied to the tube by use of an adhesive label where it can be conveniently scanned by a bar code scanner to provide the requisite information to the medical technician. In many instances, automated testing equipment is used for clinical testing of multiple sampling containers in an assembly line configuration. Such automated equipment typically involves some form of bar code scanning in order to associate the proper information with the correct sample. Bar code scanning is often done with a hand-held scanner, or alternatively, with a fixed bar code reader.

In any case, it is necessary to properly orient the blood collection tube so that the scannable bar code is conveniently presented to the bar code reader. Quite often, orientation requires manual rotation of the tube to assure that the scannable bar code can be read by the scanner. In other situations, pick and place mechanisms may be used to lift and rotate the tube to provide such orientation. As may be appreciated, individual manual rotation of a plurality of tubes is difficult, time-consuming and subject to manual error. Mechanical devices which lift and rotate the tube are cumbersome to use and costly.

Another prior art solution to the alignment of bar codes is to apply the bar code continuously around the circumference of the tube. This allows the bar code to be read regardless of the rotational orientation of the tube. However, employing a bar code label of this type has several disadvantages. First, due to the increased size of the bar code, there is little additional space for the user to apply requisite information at the blood collection site. Additionally, continuous bar code labels of this type are expensive to manufacture and difficult to apply.

Furthermore, it is also known in the prior art to utilize dual barcodes with data storage cartridges. U.S. Pat. No. 6,758,400 to Reasoner et al. discloses a system that utilizes two barcodes where each of the barcodes is partially obscured. After the partially obscured barcodes are read, an algorithm “stitches” the two barcodes together to create a single data element. However, this system requires additional software that is necessary to “stitch” the barcodes together. Barcodes of this type cannot be read with conventional barcode readers.

Additionally, it is also known in the prior art to include two barcodes having different formats on a single label. European Patent Application No. EP 0 736 854 discloses a label (10) having a barcode (12) of a first format and a barcode (14) of a second format printed thereon. More specifically, the label (10) is printed with a code 128 bar code (12) and an EAN barcode (14). The code 128 barcode (12) is adapted to be read by hand-held scanners and includes information concerning the price indicated on the label. The EAN bar code (14) can be read by a conventional scanner but not by the hand-held scanner and includes information indicating that the price of the product has been reduced. However, all of the information on this label and encoded by barcode (10) and barcode (12) cannot be accurately read if one of the barcodes is partially or totally obscured.

### SUMMARY OF THE INVENTION

A need therefore exists for a label for a collection container with barcodes that can accurately read even if one of the barcodes partially or totally obscured.

An embodiment of the invention is directed to a label comprising a first area having a first barcode printed thereon and a second area having a second barcode printed thereon. The first barcode is of a first format, the second barcode is of a second format and each barcode encodes at least a subset of identical information. The subset of identical information encoded in the first barcode and the second barcode may be information identifying the patient, the type of sample, or date or time of sampling, or any combination thereof. Additionally, all of the information encoded in the first barcode may be identical to all of the information encoded in the second barcode.

The first format may be selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, etc., and the second format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, etc. In one embodiment, the first barcode is CODE 39 and the second barcode is CODE 128.

The label may be adapted to be positioned on a sample collection container. The label may further include an alignment area and the sample collection container may include alignment symbology. The alignment area may therefore be aligned with the alignment symbology of the sample collection container, thereby allowing for proper positioning of the label on the sample collection container.

In a further embodiment, the invention is directed to a sample collection container comprising an elongate member having a first end and a second end and a label positioned between the first end and the second end. The label includes a first area with a first barcode printed thereon and a second area with a second barcode printed thereon. The first barcode is of a first format, the second barcode is of a second format and each barcode encodes at least a subset of identical information.

The subset of identical information encoded in the first barcode and the second barcode may be information identifying the patient, the type of sample, or date or time of sampling, or any combination thereof. Additionally, all of the information encoded in the first barcode may be identical to all of the information encoded in the second barcode.

The first format may be selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, etc., and the second format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, etc. In one embodiment, the first barcode is CODE 39 and the second barcode is CODE 128.

The label may further include an alignment area and the sample collection container may include alignment symbology. The alignment area may therefore be aligned with the alignment symbology of the sample collection container, thereby allowing for proper positioning of the label on the sample collection container.

In another embodiment, the invention is directed to a method of identifying information corresponding to a sample collection container. The method includes the steps of providing a sample collection container with a label adhered thereto. The label includes a first area having a first barcode of a first format printed thereon, a second area having a second barcode of a second format printed thereon. The first barcode and the second barcode encode at least a subset of identical information. After the label has been adhered to the sample collection tube the first area of the label is scanned to determine the information encoded thereon. If the step of scanning the first area of the label fails, the second area of the label is scanned to determine the information encoded thereon. At least the subset of identical information may be at least one of a content, a type, a patient and a test procedure performed corresponding to the sample collection tube. All of the information encoded in the first barcode may be identical to all of the information encoded in the second barcode. The steps of scanning may be performed by a barcode reader of an automated testing station.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a top plan view of a sample collection tube with a label including a first and second barcode in accordance with an embodiment of the present invention;

FIG. 2A illustrates data encoded using various linear barcode formats;

FIG. 2B illustrates barcodes having a two-dimensional barcode format;

FIG. 3 is a side view of the sample collection tube of FIG. 1 with scanning areas provided thereon;

FIG. 4 is a top plan view of an alternate embodiment of a sample collection container in accordance with an embodiment of the present invention;

FIG. 5A is a top plan view of a sample collection container having a first label with alignment symbology and identification symbology in accordance with an embodiment of the present invention;

FIG. 5B is a top plan view of a second label having a first and second barcode and an alignment area corresponding to the alignment symbology of the first label shown in FIG. 5A;

FIG. 5C is a portion of a view of the second label of FIG. 5B showing the first and second barcodes enlarged for magnification purposes;

FIG. 6A is a top plan view of a sample collection container having a first label with alignment symbology and identification symbology in accordance with an embodiment of the present invention;

FIG. 6B is a top plan view of a second label having a first and second barcode and an alignment area corresponding to the alignment symbology of the first label shown in FIG. 6A;

FIG. 7A is a top plan view of a sample collection container having a first label with alignment symbology and identification symbology in accordance with an embodiment of the present invention;

FIG. 7B is a top plan view of a second label having a first and second barcode and an alignment area corresponding to the alignment symbology of the first label shown in FIG. 7A; and

FIG. 7C is a portion of a view of the first label of FIG. 7A showing a first barcode and a second barcode enlarged for magnification purposes.

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

An embodiment of the present invention relates to automatic identification using barcodes on sample collection containers in automated systems. Such embodiment is specifically useful with patient specimens within the analytical systems of healthcare laboratories. A problem facing many users of such systems is the incompatibility of barcodes between different systems within a single laboratory or a group of laboratories. An incompatibility problem arises in various situations. For instance, the physical position of the barcode on the sample collection container may not suit multiple systems because the barcode may be obscured by the carrier of the system. Furthermore, the barcode format may not be compatible with certain systems. An embodiment of the present invention addresses these issues by providing a label with multiple barcodes in different positions and of different formats.

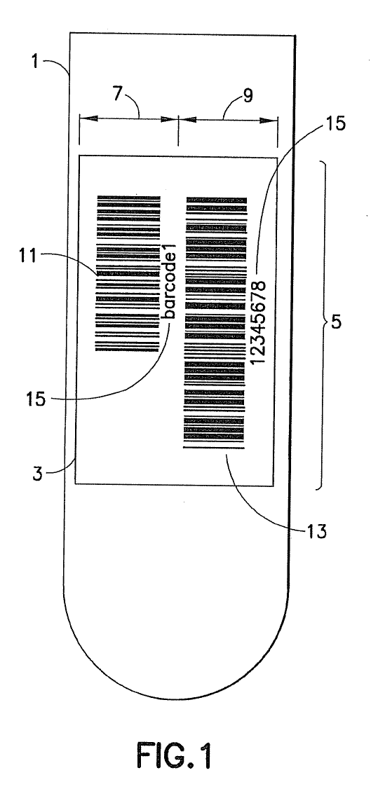

With reference to FIG. 1, a container 1 includes a label 3 affixed to an outer surface of container 1 at a label bearing area 5. Label 3 includes a first area 7 and a second area 9. First area 7 includes a first barcode 11 printed thereon, and second area 9 includes a second barcode 13 printed thereon. First area 7 and second area 9 may further include alphanumeric indicia 15 printed thereon. First barcode 11 and second barcode 13 are each of different formats; however, at least a subset of information encoded in first barcode 11 is identical to at least a subset of information encoded in second barcode 13.

First and second barcodes 11 and 13 are each capable of encoding a certain amount of information. Usually, first and second barcodes 11 and 13 are encoded with less information than they are capable of encoding. Accordingly, first and second barcodes 11 and 13 can be encoded with identical information. Thereafter, depending on the format of the barcodes, each of the barcodes may have additional capacity to encode additional information. Therefore, only a subset of the information encoded by the first barcode 11 and second barcode 13 is identical. However, in some embodiments of the invention, all of the information encoded in first and second barcodes 11 and 13 is identical.

Any type of identification may be encoded by the barcodes. For example, the barcodes may include a unique identifier, such as a unique series of numbers, with the identifier having no relevance or significance other than acting as a unique identifier. In such a case, the identifier may be useful as a tracking number when matched with other information, such as patient identification information. In such an embodiment, the barcodes may be associated with the collection containers directly at the manufacturer, such that the tracking number can be later associated with additional information, such as patient identification, at the point of use. In other embodiments, the information encoded by the barcodes may include, for example, an identification of the sample contained within the container, information identifying the patient, what analyses are to be conducted on the sample and sampling information such as date and time of sampling, and the like. In still further embodiments, the information encoded in the barcodes may include information related to the patient such as the Medical Record Number (MRN), Account Identifier, Wristband Identifier, Global Identifier, age of the patient, name of the patient, date of birth, disease state, diagnosis, billing information, insurance provider, account number, location, driver's license information, next of kin, and the like. Additionally, the information may include the Accession Number, which is a number associated with a collected specimen that is tied back to a patient in a Laboratory Information System (LIS). Other information that may be encoded in the barcodes and tied back to a patient in a LIS may include tube type, tube volume, test type, diagnostic test, time of test, location or any combination thereof. In additional embodiments, the information encoded in the barcodes may include information gathered at the time the label is printed such as the user ID of the specimen collector and/or the label print date and time.

Several different barcode formats may be utilized. The barcode format refers to a pre-determined manner in which barcodes encode alphanumeric text. Barcode formats may be classified into at least two categories: linear or one-dimensional; and two dimensional.

Linear bar code formats comprise a single row of bars and spaces that are read by scanning the bar code predominately along a scanning line substantially perpendicular (90°) to the individual elements comprising the barcode symbol. Scanners are frequently capable of interpreting linear bar codes even when scanned at significant departures from 90°.

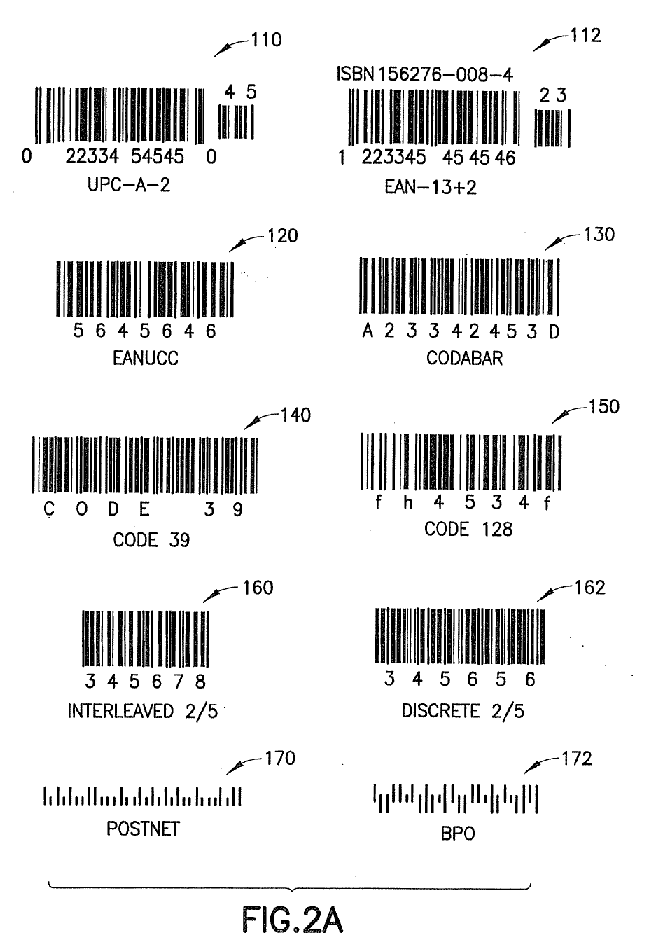

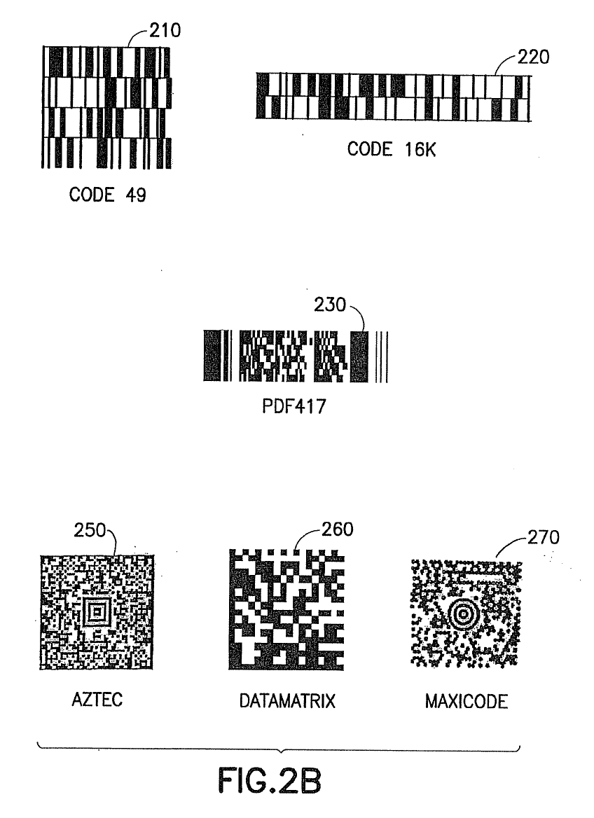

With reference to FIGS. 2A and 2B, numerous barcode formats have been developed, each with features particular to its intended use. For example, code 39 is a variable length barcode used predominately in the non-retail field. Code 39 provides for an optional checksum character as well as concatenation of bar codes that are not continuous. Universal Product Code (including UPC-A and UPC-E) is a format used predominately in retail sales. UPC-A, for example allows for an 11 character code and a checksum character. The first character identifies the type of product being identified. The following 5 characters identify a manufacturer. The last 5 characters are typically used to identify a specific product.

FIG. 2A illustrates bar code symbols for a variety of linear barcode formats including Code 39 (140), interleaved 2 of 5 (160), discrete 2 of 5 (162), Universal Product Code +2 (110), European Article Number-13+2 (112), EANUCC (120), Code 128 (150), and Codabar (130). Information is encoded by varying the width and sequence of the bars. Some of these barcode formats may be susceptible to “short-scanning”. For example, if a portion of a barcode is obscured during scanning, the scanning system may be adaptable to read a truncated number, such as with interleaved 2 of 5 (160) format. Accordingly, such barcode formats which are susceptible to short-scanning may be unsuitable for use with the present invention if the barcode is partially obscured by a transport mechanism, particularly in systems which are adaptable to short-scanning.

Other one-dimensional barcodes store information by varying the height of the bars. For example, PostNet (170) utilized by the United States Postal Service stores information by varying the height of the bars while maintaining a constant distance between bars. Another barcode format, BPO 172, is used by the British Post Office. BPO 172 provides for varying lengths or positions of the bars along one axis while maintaining equidistant spacing between bars along a perpendicular axis.

Generally, linear barcode formats vary parameters such as the width of the bars, height of the bars, distance between bars, and combinations of these parameters to encode information.

Two-dimensional barcodes can be further classified as “stacked” or “matrix.” Stacked bar codes comprise several rows of linear bar codes stacked one on top of another. Stacked bar codes may be read by multiple linear scans sufficiently displaced to ensure each of the individual rows is ultimately uniquely scanned. FIG. 2B illustrates examples of stacked bar codes including Code 49 (210), Code 16K (220), PDF417 (230), and CodaBlock (240).

Matrix barcode formats consist of polygonal arrays of data cells and orientation structures. Matrix bar code symbols are scanned using an array of sensors rather than a single sensor. Exemplary matrix bar code symbologies include Data Matrix 260, Maxicode 270, Aztec 250 and Vericode (not shown).

In accordance with an embodiment of the invention, label 3 utilizes a Code 39 barcode and a Code 128 barcode.

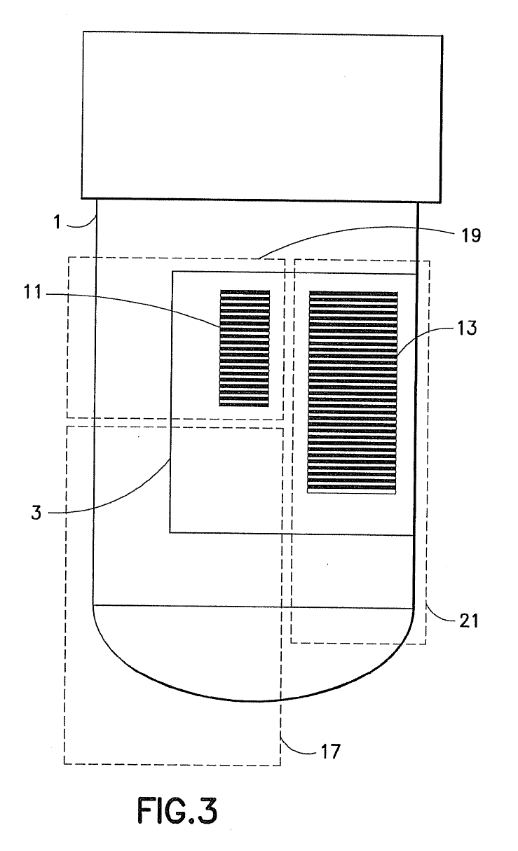

With reference to FIG. 3, and with continuing reference to FIG. 1, label 3 allows for the proper identification of sample collection container 1 regardless of the type of system that is used to read barcodes 11 and 13. For instance, if the ADVIA LabCell and WorkCell systems (manufactured by Bayer Diagnostics) are utilized by a laboratory, a portion 17 of label 3 is obscured by a puck that is used to hold container 1. Therefore, if container 1 is not oriented properly, the ADVIA LabCell and WorkCell systems cannot obtain an accurate reading of barcode 13 by scanning area 21 because it is obscured by the puck used to hold container 1. However with barcode 11 also present on label 3 and including the same information, the scanner can scan area 19 and receive an accurate reading of barcode 11. For example, in one particular method scanning area 21 of label 3 is scanned to determine the information encoded thereon. If this scan leads to a failed reading (i.e., the scanner cannot read the information encoded in barcode 13 due to an obstruction, etc.), the scanner can move to scanning area 19 of label 3 thereby scanning barcode 11 to determine the information encoded thereon. Accordingly, an accurate scan can be accomplished regardless of whether the equipment obstructs a portion of barcode 13, since a second barcode 11 is also present with at least a subset of the same information although stored in a different barcode format.

Many other handling systems utilize auto-discriminating barcode scanners. Such scanners can detect and read barcodes having various formats. Accordingly, if first barcode 11 or second barcode 13 is partially or fully obscured by the handling system, the auto-discriminating barcode scanner can still identify the collection container 1 by reading the barcode that is not obscured by the handling system. Therefore, the system operator can place collection container 1 into the handling system without worrying about the orientation of collection container 1.

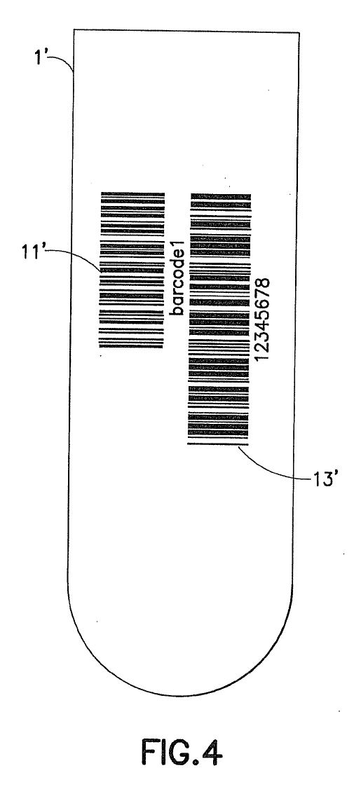

With reference to FIG. 4, another embodiment of the present invention may provide for a sample collection container 1′ with a first barcode 11′ and a second barcode 13′ printed directly thereon. Similar to the first embodiment, first barcode 11′ and second barcode 13′ are of different barcode formats, but encode the same information.

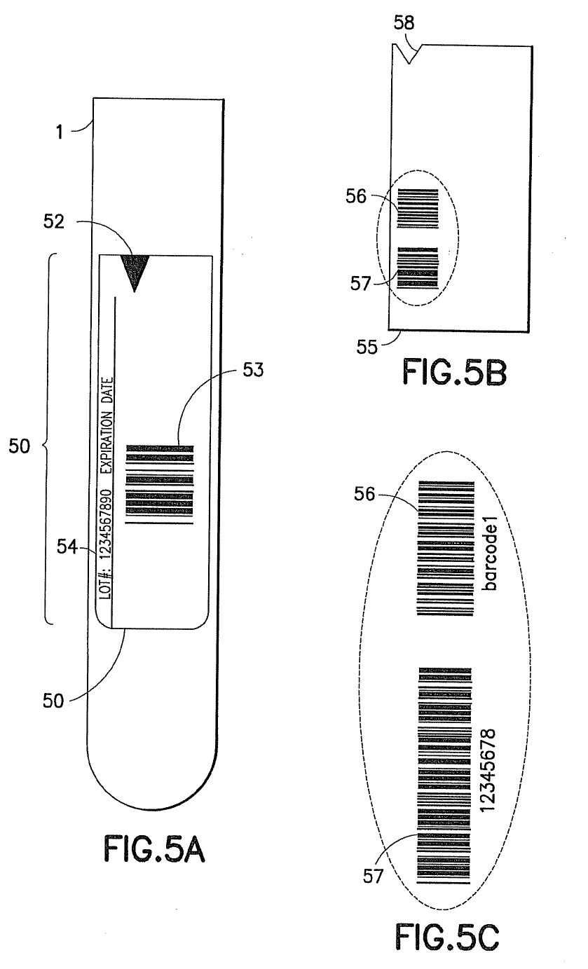

With reference to FIGS. 5A-5C, 6A, 6B and 7A-7C, alternate embodiments of the present invention are illustrated. As shown in FIG. 5A, container 1 includes a first label 50 affixed to the outer surface of container 1 or label bearing area 51, with alignment symbology 52 printed thereon. First label 50 may further contain additional encoded or printed information thereon such as container identification symbology. Such identification symbology includes a bar code 53 and/or an alphanumeric indicia 54, either or both of which may include, but is not limited to, information identifying the specific type of the container, the manufacturer lot number, the expiration date, the size and/or shape of the container and the reagents and/or additives included within the container.

With reference to FIGS. 5B and 5C, and with continued reference to FIG. 5A, an identification label 55 is provided for placement on container 1. Identification label 55 includes a first barcode 56 and a second barcode 57 printed thereon. First barcode 56 and second barcode 57 are each of different formats; however, at least a subset of the same information is encoded by each of the barcodes. As with prior embodiments, the information may be any type of information, including identification or tracking information.

Identification label 55 is provided as a second label capable of being affixed over first label 50. Identification label 55 further includes an alignment area 58 corresponding to alignment symbology 52 of first label 50. Alignment area 58 may be, for example, an opening or notched cut-away of identification label 55. For example, as shown in FIGS. 5A and 5B, alignment symbology 52 is in the form of a v-shaped triangle and alignment area 58 is a v-shaped notch appearing on the edge of identification label 55. Alternatively, alignment area 58 may be a transparent portion having a shape designed to fit over alignment symbology 52.

Identification label 55 is positioned on container 1 such that alignment area 58 of identification label 55 is aligned with alignment symbology 52 of first label 50, with alignment symbology 52 being detectable through alignment area 58, thereby assuring proper alignment of the identification label on container 1.

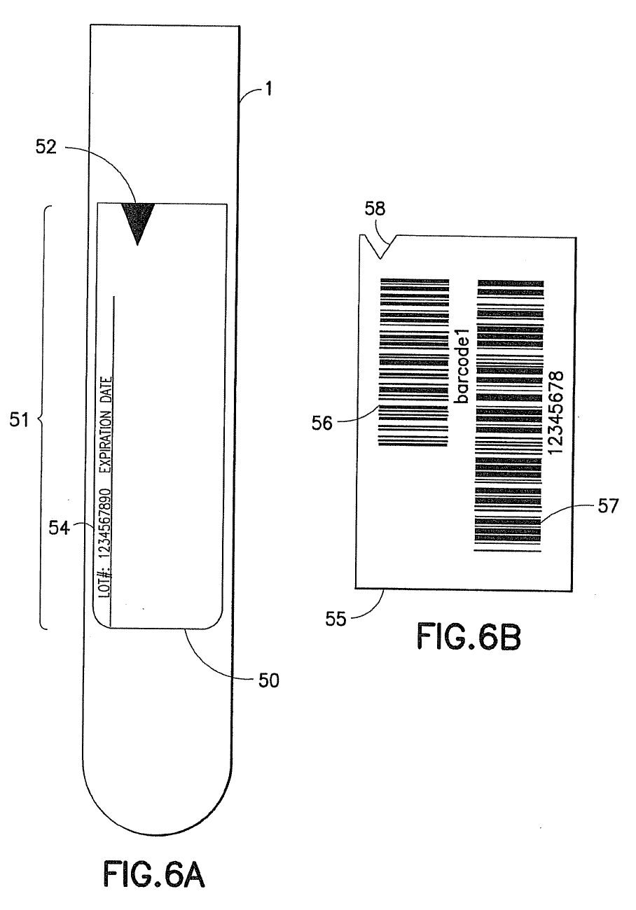

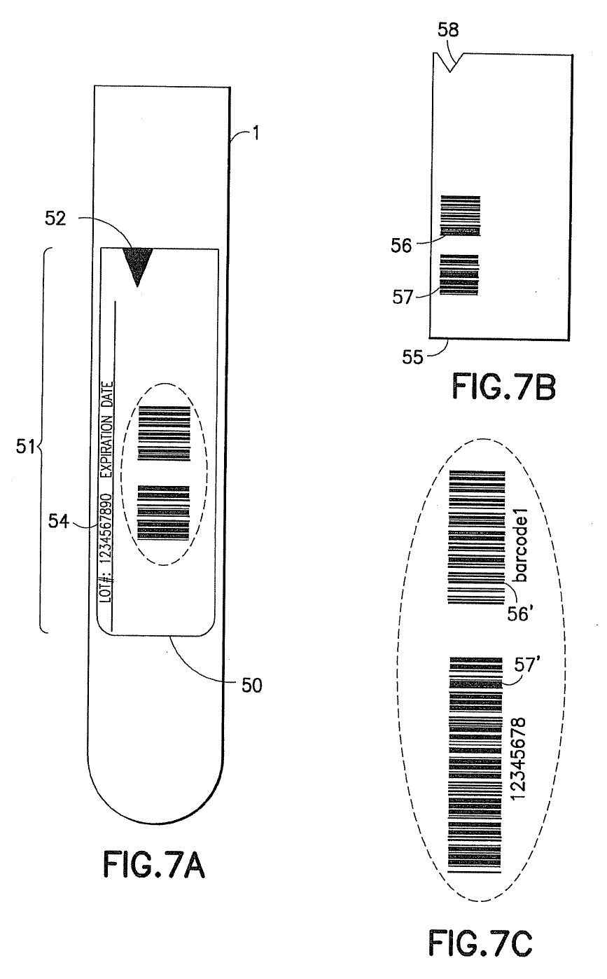

With reference to FIGS. 6A and 6B, first label 50 may alternatively include only alphanumeric indicia 54 without a barcode. With reference to FIGS. 7A-7C, first label 50 may include a first barcode 56′ and a second barcode 57′ that correspond to first barcode 56 and second barcode 57 of identification label 55.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, while the embodiments illustrated herein show two barcode formats on a label or container, three or more formats may be used. In addition, while various barcode format types are listed herein, other barcode formats not listed may be utilized by the one or more embodiments of the present invention. Also, while the embodiments are illustrated with barcodes displayed on one or more labels, in accordance with an embodiment of the invention, one or more of the barcodes may be displayed directly on the container. Furthermore, while information is provided by barcodes of different formats in accordance with an embodiment of the present invention, in yet another embodiment some other form of machine readable code may be used. Moreover, it is to be understood that the present invention contemplates that, to the extent possible, one or more features of any embodiment can be combined with one or more features of any other embodiment.

The invention claimed is:

1. A label comprising:
a first area having a first barcode printed thereon; and
a second area having a second barcode printed thereon,
wherein the first barcode is of a first format, the second barcode is of a second format and each barcode encodes at least a subset of identical information.

2. The label of claim 1, wherein the first format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, and the second format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE.

3. The label of claim 1, wherein the first format is CODE 39 and the second format is CODE 128.

4. The label of claim 1, wherein the label is adapted to be positioned on a sample collection container.

5. The label of claim 4, wherein the label includes an alignment area and the sample collection container includes alignment symbology.

6. The label of claim 5, wherein the alignment area is aligned with the alignment symbology of the sample collection container thereby allowing for proper positioning of the label on the sample collection container.

7. The label of claim 1, wherein the subset of identical information encoded in the first barcode and the second barcode is information identifying the patient, the type of sample, or date or time of sampling, or any combination thereof.

8. The label of claim 1, wherein all of the information encoded in the first barcode is identical to all of the information encoded in the second barcode.

9. A sample collection container comprising:
an elongate member having a first end and a second end; and
a label positioned between the first end and the second end, the label having a first area with a first barcode printed thereon and a second area with a second barcode printed thereon,
wherein the first barcode is of a first format, the second barcode is of a second format and each barcode encodes at least a subset of identical information.

10. The sample collection container of claim 9, wherein the first format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, and the second format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE.

11. The sample collection container of claim 9, wherein the first format is CODE 39 and the second format is CODE 128.

12. The sample collection container of claim 9, wherein the label includes an alignment area and the sample collection container includes alignment symbology.

13. The sample collection container of claim 12, wherein the alignment area is aligned with the alignment symbology of the sample collection container thereby allowing for proper positioning of the label on the sample collection container.

14. The sample collection container of claim 9, wherein the subset of identical information encoded in the first barcode and the second barcode is information identifying the patient, the type of sample, or date or time of sampling, or any combination thereof.

15. The sample collection container of claim 9, wherein all of the information encoded in the first barcode is identical to all of the information encoded in the second barcode.

16. A method of identifying information corresponding to a sample collection container, the method comprising the steps of:
providing a sample collection container with a label adhered thereto, the label comprising: a first area having a first barcode of a first format printed thereon, a second area having a second barcode of a second format printed thereon, the first barcode and the second barcode encoding at least a subset of identical information;
scanning the first area of the label to determine the information encoded thereon; and,
if the step of scanning the first area of the label fails, scanning the second area of the label to determine the information encoded thereon.

17. The method of claim 16, wherein the subset of identical information is at least one of a content, a type, a patient and a test procedure performed corresponding to the sample collection container.

18. The method of claim 16, wherein the first format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE, and the second format is selected from the group of UPC, EAN, EANUCC, CODABAR, CODE 39, CODE 128, Interleaved 2/5, Discrete 2/5, Postnet, BPO, CODE 49, CODE 16K, PDF417, AZTEC, DATAMATRIX and MAXICODE.

19. The method of claim 16, wherein the steps of scanning are performed by a barcode reader of an automated testing station.

20. The method of claim 18, wherein all of the information encoded in the first barcode is identical to all of the information encoded in the second barcode.
